(19) United States
(12) Patent Application Publication
(10) Pub. No.: US 2001/0040992 A1
(43) Pub. Date: Nov. 15, 2001

(54) METHOD AND SYSTEM FOR VIEWING AND EVALUATING DIAGNOSTIC QUALITY DIFFERENCES BETWEEN MEDICAL IMAGES

(76) Inventors: DAVID H. FOOS, WEBSTER, NY (US); KEVIN S. KOHM, FAIRPORT, NY (US); BRIAN J. TERWILLIGER, MENDON, NY (US)

Correspondence Address: PATENT LEGAL STAFF, EASTMAN KODAK COMPANY, 343 STATE STREET, ROCHESTER, NY, 14650-2201, US

(21) Appl. No.: 09/199,984

(22) Filed: Nov. 25, 1998

(51) Int. Cl. G06K 9/00

(52) U.S. Cl. 382/130

(57) ABSTRACT

A method of viewing and evaluating diagnostic quality differences between medical images comprising the steps of: providing at least two versions of the same medical image; and sequentially displaying the at least two versions co-registered on a high resolution electronic display to facilitate a viewers evaluation of diagnostic quality differences between the versions of medical image.

### FIELD OF THE INVENTION

This invention relates in general to digital medical imaging, and in particular to the evaluation of diagnostic quality differences between medical images that have been prepared for viewing using alternate techniques.

### BACKGROUND OF THE INVENTION

Evaluating quality differences between medical images is important for selecting the best presentation technique for diagnosis. There are two image evaluation methods that are currently accepted by medical researchers for this purpose. The first, Receiver Operating Characteristic (ROC) analysis, requires that physicians diagnose from a set of images that have been prepared using one presentation technique and then reinterpret at a later date the same set of images that have been prepared using an alternate presentation technique. The presentation techniques are considered to be visually indistinguishable, and hence diagnostically indistinguishable if the evaluation results indicate the physician was guessing. Both ROC and AFC evaluation methods require the sue of images that contain subtle disease states in order to differentiate among presentation techniques. This is because images that show conspicuous disease would likely be diagnosed correctly regardless of presentation technique. Subtle effects are difficult to detect, hence a large number of images must be evaluated to produce a statistically meaningful result. In addition, subtle effects cause the evaluation process to be slow. It is therefore necessary to provide a means for evaluating diagnostic quality differences among images that is efficient and to provide a method that enables physicians to more easily detect subtle differences among images. Such a method would allow more images to be evaluated in the same amount of time and facilitate the selection of presentation techniques that result in improved diagnosis.

The following are representative of the prior art.

U.S. Pat. No. 5,797,843, issued Aug. 25, 1998, inventors Geoffrey Fitch, et al.

U.S. Pat. No. 4,825,388, issued Apr. 25, 1989, inventors David Dailey, et al.

Charles E. Metz, Basic Principles of ROC Analysis, Seminars in Nuclear Medicine, Vol. VIII, No. 4, 1978.

Charles E. Metz, Some Practical Issues of Experimental Design and Data Analysis in Radiological ROC Studies, Invest Radiol 1989, 24, pp. 234-245.

Charles E. Metz, ROC Methodology in Radiologic Imaging, Invest Radiol 1986, 21, pp. 720-733.

Arthur E. Burgess, Comparison of Receiver Operating Characteristic and Forced Choice Observer Performance Measurement Methods, Med. Phys. 22 (5), May 1995.

David Gur et al., Forced Choice and Ordinal Discrete Rating Assessment of Image Quality: A Comparison, Journal of Digital Imaging, Vol. 10, No. 3, August 1997;pp. 103-107.

### SUMMARY OF THE INVENTION

According to the present invention, there is provided a solution to the problems of the prior art.

The present invention allows for the sequential display (flicker) of two or more co-registered high resolution monochrome images on the same monitor with interactive controls for flicker rate, magnification, and test marker image selection.

### ADVANTAGEOUS EFFECT OF THE INVENTION

The invention has the following advantages.

1. Subtle differences between versions of the same image can be identified more easily.

2. Different versions of the same image can be evaluated more rapidly.

### BRIEF DESCRIPTION OF THE DRAWINGS

FIGS. 1a-1c show various options for sequential display and evaluation of two or more co-registered images on a computer monitor.

FIG. 2 is a block diagram of an image processing and display system configuration useful in carrying out the present invention.

### DETAILED DESCRIPTION OF THE INVENTION

This invention requires that multiple processed versions of the same image be displayed on a computer monitor such that while only one version is displayed at a time, subsequent displayed versions of the image are co-registered to the first image displayed. Selection of which version of the image to be displayed is controlled by the observer. The image set may also be magnified so that the images are still registered upon subsequent image display. While the implementation of this invention described below utilizes preprocessed versions of the original image stored on the computer hard disk drive, on-the-fly processing to create the multiple versions of the images is possible.

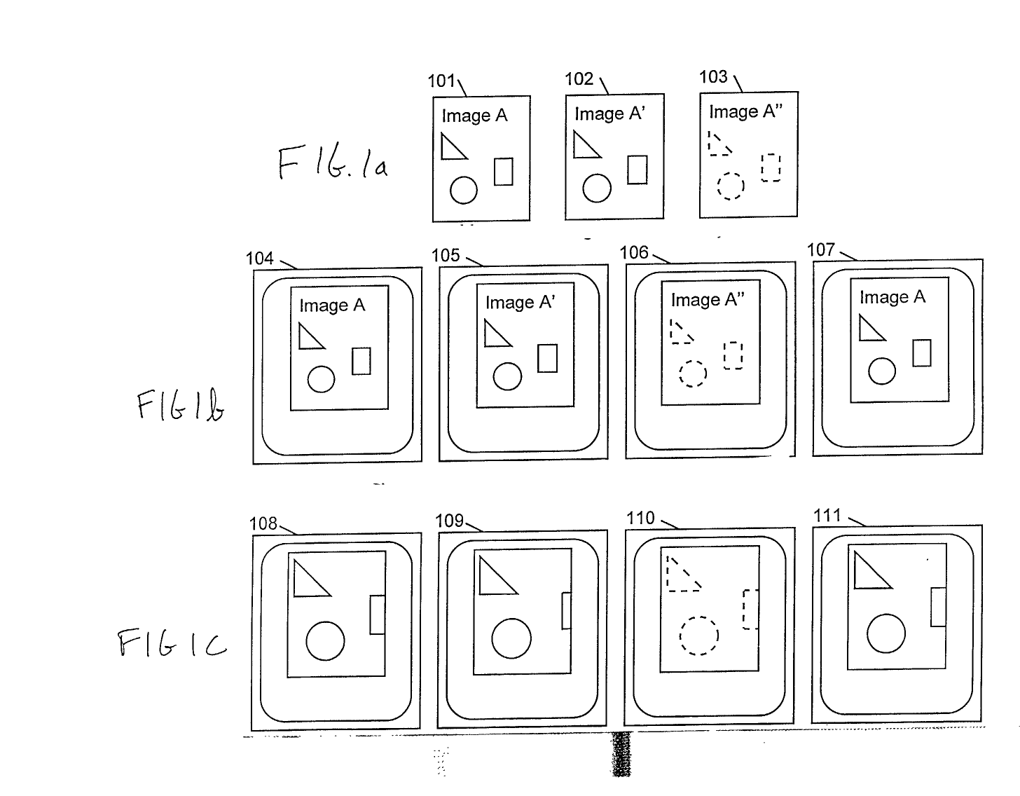

The operation of this invention is better described with the use of the example in FIGS. 1a-1c. As shown in FIG. 1a, three versions of the same image are used in this example: Image A (101), Image A′(102), and Image A″(103). As shown in FIG. 1b, initially, at time t1, Image A is displayed on the Computer Monitor. This is shown in item 104. At some later time, t1+t2, the observer selects Image A′to be displayed on the Computer Monitor. This is shown in item 105, note that Image A′is in the same location as Image A was in item 104. Later, at time t1+t2+t3, the observer selects Image A″to be displayed on the Computer Monitor, as shown in item 106. At time t1+t2+t3+t4, the observer again selects Image A to be displayed on the Computer Monitor as in item 107.

A magnified or demagnified version of the image set may also be displayed in a similar way. As shown in FIG. 1c, item 108 depicts the Computer Monitor with a magnified version of Image A displayed at time t5. Item 109 shows the Computer Monitor after the user then selects Image A′to be displayed at time t5+t6. Notice that the same portion of Image A′in 109 is displayed as Image A in 108 and the images are in the same location. Item 110 shows the Computer Monitor when the user selects Image A″at time t5+t6+t7. Item 111 shows the Computer Monitor when the user again selects Image A to be displayed at time t5+t6+t7+t8.

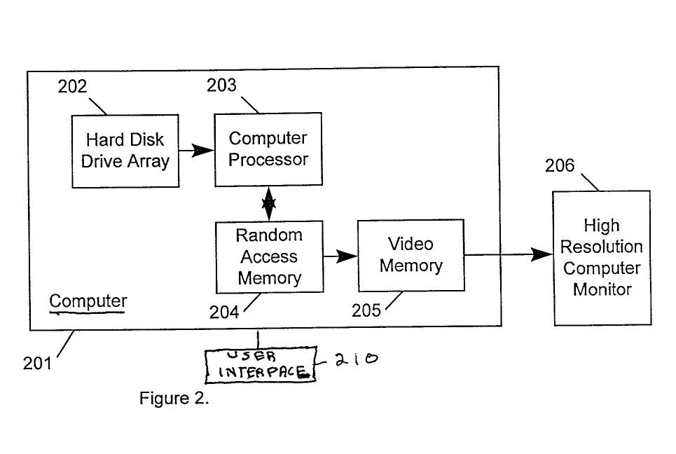

The system configuration shown in FIG. 2 produce the results described in the example above. The computer (201) displays all images on a High Resolution Computer Monitor (206). For the medical imaging application of this invention, a 2048×2500 pixel monochrome monitor is used. The multiple versions of the image are stored on the Hard Disk Drive Array (202). In order to achieve the desired speed of image display, all of the multiple versions of the same image are read by the Computer Processor (203) and placed in Random Access Memory (204). When the observer selects a version of the image to be displayed, that image is copied from Random Access Memory to Video Memory (205) which then displays that image on the High Resolution Computer Monitor. When the observer selects a different version of the image, the selected version is then copied from Random Access Memory 204 to Video Memory 205 for subsequent display on the High Resolution Computer Monitor 206.

Various user interfaces 210 may be used for the observer to select which image is to be displayed, the rate at which the images are displayed (flicker rate), and at what magnification the images are displayed. Interfaces 210 can, for example, be a Graphical User Interface, a mouse or other computer peripheral, or the computer keyboard.

The example described above utilizes one image processed in multiple ways. Let us call this an image set. In an experiment it may be desired that multiple image sets are used. In this case, after the observer has completed viewing the images from one image set, that entire set is deleted from Random Access Memory 204 and the next image set is read from the Hard Disk Drive Array 202 and stored in Random Access Memory 204. In this way, the speed of viewing any image in an image set is preserved while reducing the total Random Access Memory 204 required as all image sets do not need to be loaded simultaneously.

The invention has been described in detail with particular reference to certain preferred embodiments thereof, but it will be understood that variations and modifications can be effected within the spirit and scope of the invention.

### Parts List

201 computer

202 hard disk drive array

203 computer processor

204 random access memory

205 video memory

206 high resolution computer monitor

210 user interface

What is claimed is:

1. A method of viewing and evaluating diagnostic quality differences between medical images comprising the steps of:
providing at least two versions of the same medical image; and
sequentially displaying said at least two versions co-registered on a high resolution electronic display to facilitate a viewers evaluation of diagnostic quality differences between said versions of medical image.

2. The method of claim 1 including the step of controlling the rate at which said image versions are displayed.

3. The method of claim 1 including the step of controlling the magnification at which said image versions are displayed.
